(19) United States
(12) Patent Application Publication
(10) Pub. No.: US 2016/0005064 A1
(43) Pub. Date: Jan. 7, 2016

(54) System and Method for Music-based Social Interaction

(71) Applicants: Paul Joseph Pedroni, Fircrest, WA (US); Robert Addison Case, Bellevue, WA (US); Randolph Edward Kath, Seattle, WA (US)

(72) Inventors: Paul Joseph Pedroni, Fircrest, WA (US); Robert Addison Case, Bellevue, WA (US); Randolph Edward Kath, Seattle, WA (US)

(21) Appl. No.: 14/638,594

(22) Filed: Mar. 4, 2015

Related U.S. Application Data
(60) Provisional application No. 61/947,987, filed on Mar. 4, 2014.
(60) Provisional application No. 61/977,516, filed on Apr. 9, 2014.

(51) Int. Cl. G06Q 30/02; G06F 3/0484; H04L 29/06; G06F 3/0482; G06Q 50/00; H04L 29/08

(52) U.S. Cl. CPC G06Q 30/0214; G06Q 50/01; H04L 67/1082; H04L 65/403; G06F 3/0482; G06F 3/04842

(57) ABSTRACT

A system for music-based social interaction. A first user selects a song for sharing with a second user along with a verbal message. The second user receives notice that the song is available to be played on a device controlled by the second user. The second user plays the song and reads the message while a count-down display graphically shows the progress of the song in its play from beginning to end. The song is then automatically erased after play is completed, unless the second user elects either to buy it, or to send it further along to a third user, in which case, for every further send along to the third or subsequent users, the second user has the right to play the song one more time.

### CROSS REFERENCE TO RELATED APPLICATIONS

This application claims priority to the following two U.S. Provisional Patent applications, each of which is hereby incorporated by this reference as if fully set forth herein: 61/947,987 filed Mar. 4, 2014 and 61/977,516 filed Apr. 9, 2014.

### TECHNICAL FIELD

This disclosure relates to system for social interaction, and more particularly to a music-based social interaction.

### BACKGROUND

Digital life has dramatically impacted individual user behaviors. We do email instead of letters. Text instead of calling Facebook instead of visits. Music has become a private and individual listening experiences. The communal experience is gone. We no longer have that synchronized moment of discovery. Other forms of media have vehicles for sharing. Music has not enjoyed this Social Media renaissance. As a result, both consumers and the music business suffer.

### DISCLOSURE

In it's simplest form this technology is about defining a “music message” as a unique form of digital communication (unlike email & text) that is enhanced with song content elements (album art, metadata information & on-demand streaming) that add context thru visual and audible association with the music elements, and provoke an heightened emotional connection in the receiver.

The disclosed technology combines music elements in such a way as to create a unique message experience, and the unique information flow is a function of how the music and message information elements are combined resulting in a unique receiver experience.

### EXAMPLES

1) User creates a “music message” which comprises at least one song and some text that when combined together convey a form of communication that includes enhanced contextual meaning thru visual impression of the artwork, the word(s) in the song title and the inherent emotional connection with the song supplied by the sender of the message (e.g. our first song together—for a special song they share, feeling melancholy today—perhaps a new song that capture your feeling, New chart topper?—some song which you're going out on a limb to claim its superiority, etc).

2) User receives a “music message” and is able to experience the enhanced communication in a wholly unique and richer way that includes all of a) playing the song, b) examining the artwork and music metadata, c) reading the message and d) having the ability in situ to reply to the message with a “music message” of their own.

A social network for sharing music is disclosed. The user experiences and interacts with this network via a proprietary application or app. This re-ignites the communal experience of music.

Users share music with the richness of a dedicated Social Media network, discovering music & sharing “Jukeboxes”. This App unlocks music's social potential in the digital age, much like how radio unlocked it for generations in the analog age.

### How It Works

Notification—Text like notification when a song arrives

Share—Users browse through a library of full length licensed songs and bomb to friends via their contacts or Facebook. Users can create groups of friends as well as bomb to Facebook and Twitter friends and followers

Listen—Users listen to the song instantly and continue the conversation in real time text. When the song plays it expires and takes listeners to an action screen.

Verified Artists—Artists (signed and un-signed) can boom a song to their fan base through Facebook, Twitter or to followers

Continuous Play—Users can start a “Jukebox” and invite friends to contribute. In a party situation, the Jukebox can become crowd sourced as listeners “thumb up” or “thumb down” during playback (if majority thumbs down Jukebox goes to the next song)

The App is Simple. Like a text message, the app does one thing really well—spontaneous, in-the-moment song sharing by consumers and verified artists.

Licensed Music. This is the only music messaging app with licensing agreements with Major Record Labels. These IP deals allow sharing of full length tracks as well as verified artist involvement leading to aggressive user growth

Continuous Play/Jukebox. Users build interactive Jukeboxes that can be crowd-source programmed in real time where the majority rules the playback with thumb up and thumb down.

### BRIEF DESCRIPTION OF THE DRAWINGS

FIGS. 1 through 6 are schematic flowcharts of aspects of the disclosed system.

FIGS. 7 through 12 are screen shots of aspects of the disclosed system.

### DETAILED DESCRIPTION

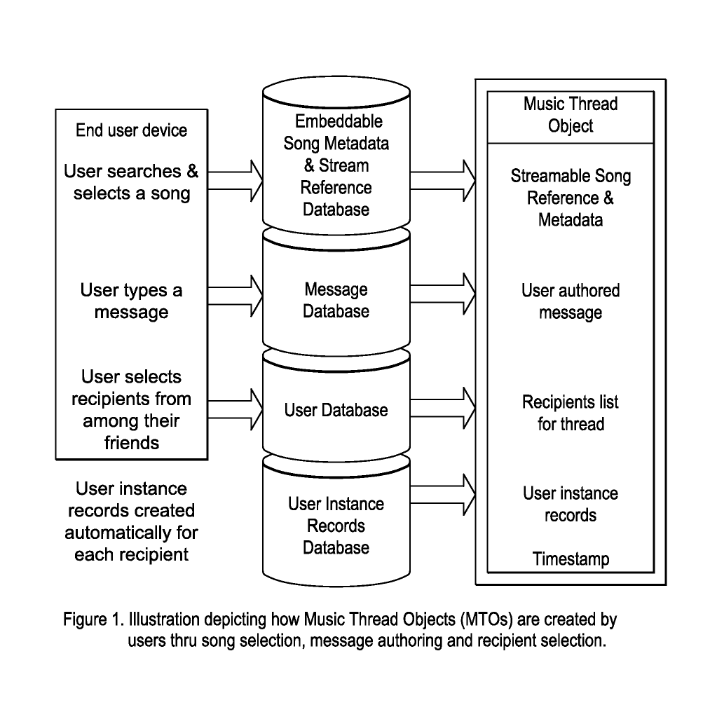

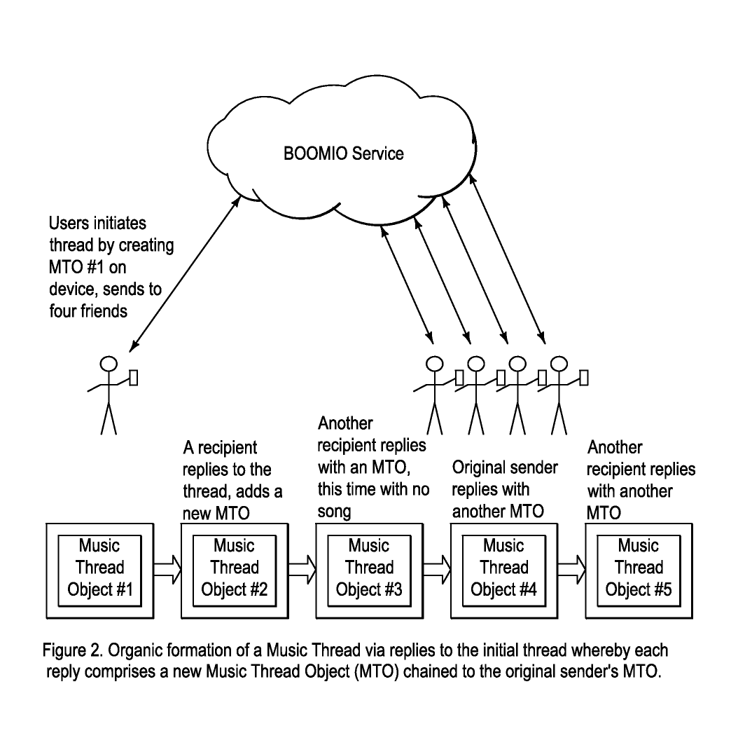

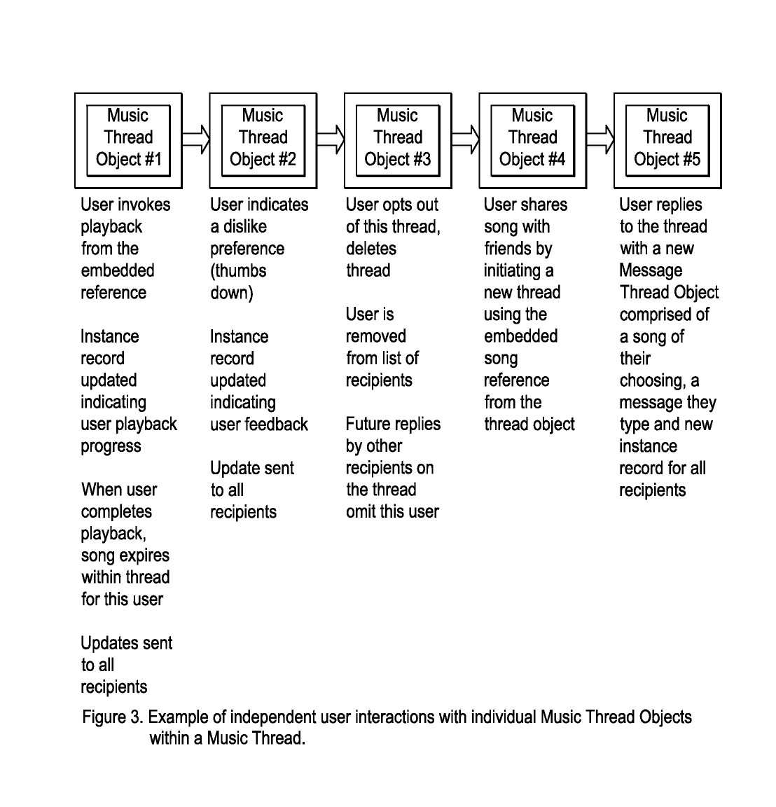

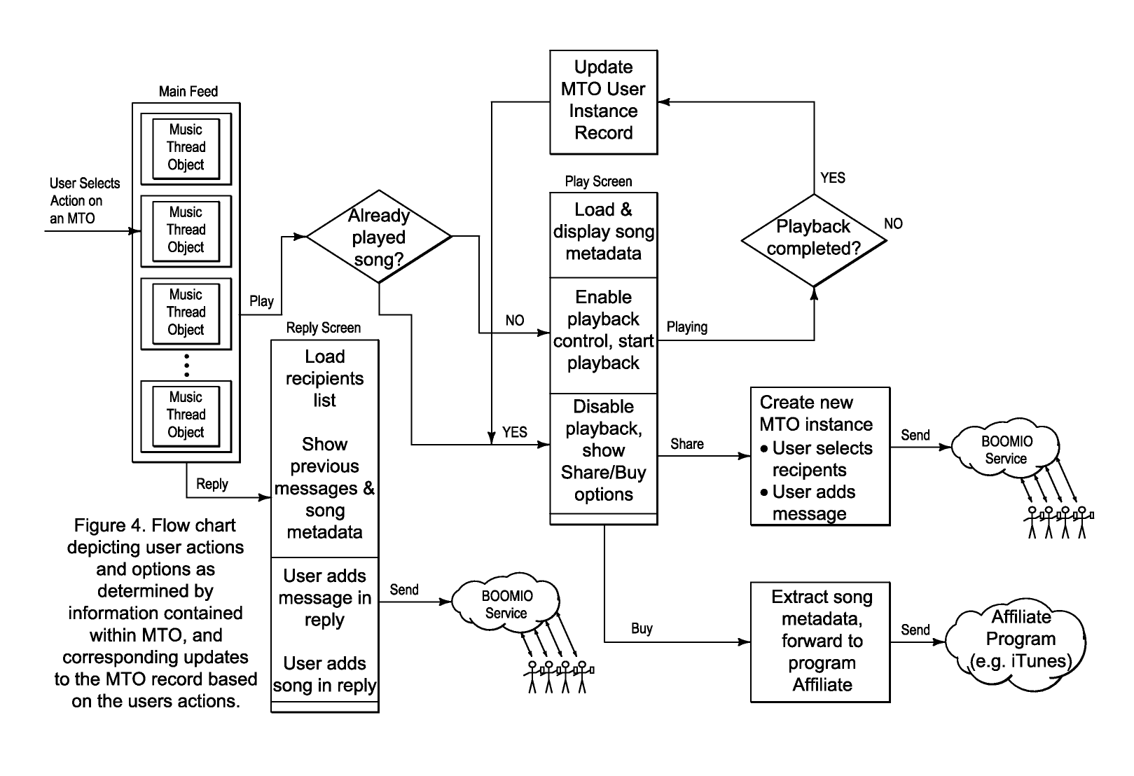

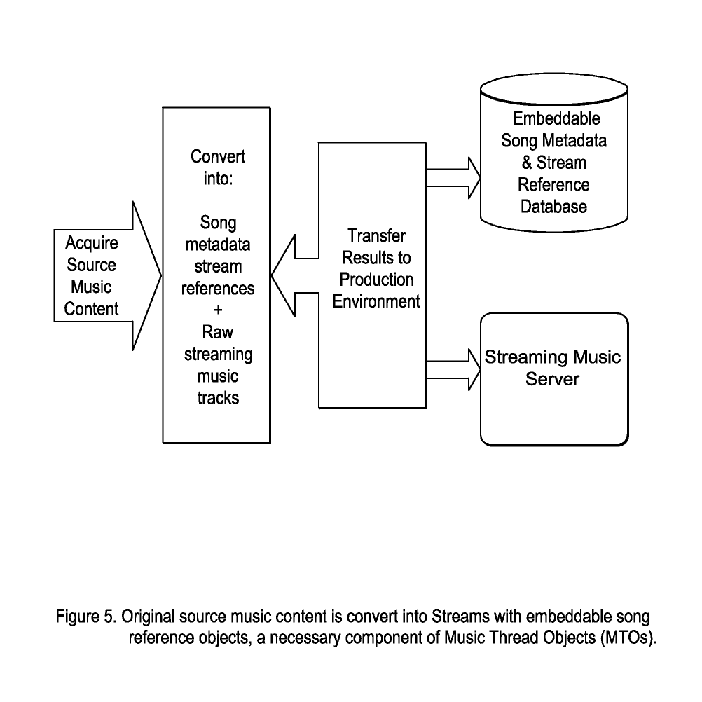

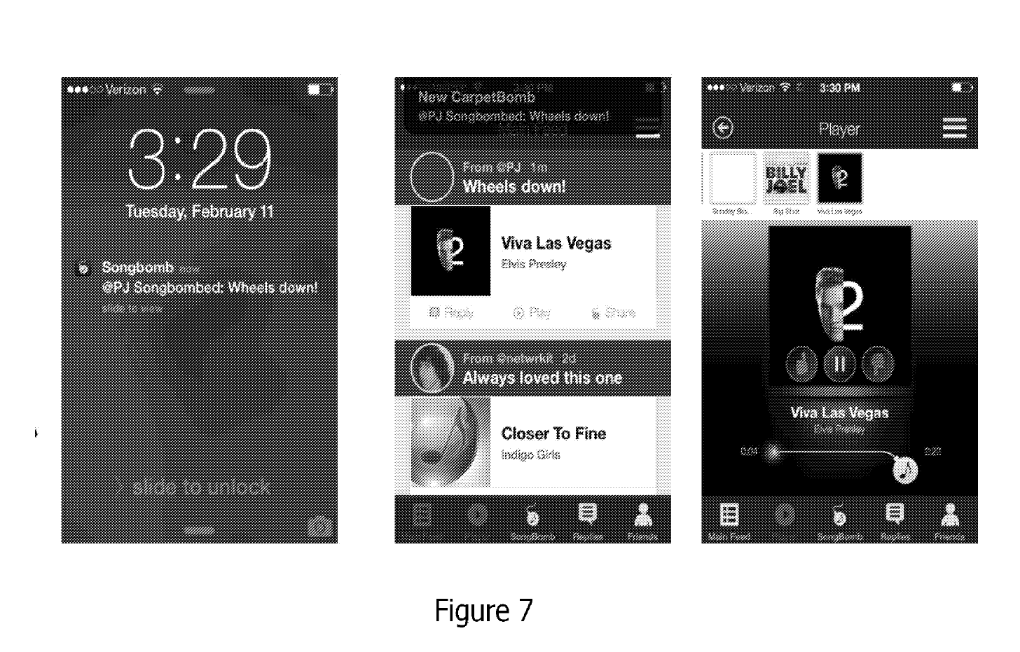

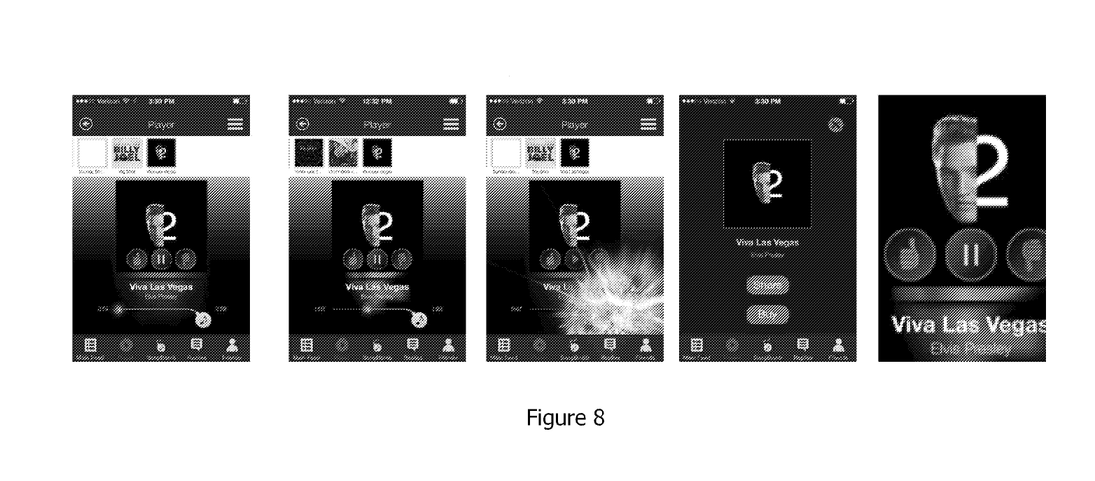

FIGS. 1 through 6 are schematic flowcharts of aspects of the invention, the details of which are evident in the drawing figures. Notification (See FIG. 7)
1. User sends a song (also referred to herein as a Boom or a Bomb or a songbomb) or replies to a message
2. ios notification appears on the lock screen of user device
3. User clicks on the in-app notification and the app goes to the specific event pertaining to the notification
4. User can listen/Play if they were sent a song, read/respond to message if they were sent a message or accept/deny if they were sent a friend request Playback (See FIG. 8)
1. User can Listen to entire song or pause it.
2. As the song begins to play, a virtual “fuse” (animation) begins burning down to a bomb icon in place of a progress bar
3. after listening to the entire song it “blows up” or expires creating a forced action
4. After blow up user sees an action screen with the ability to share the song and receive another play and/or user can buy the song from iTunes or“X” out of the action screen
5. User can positively or negatively respond to that song with a thumbs Up/Down
6. User can choose to share that song by clicking on the album art

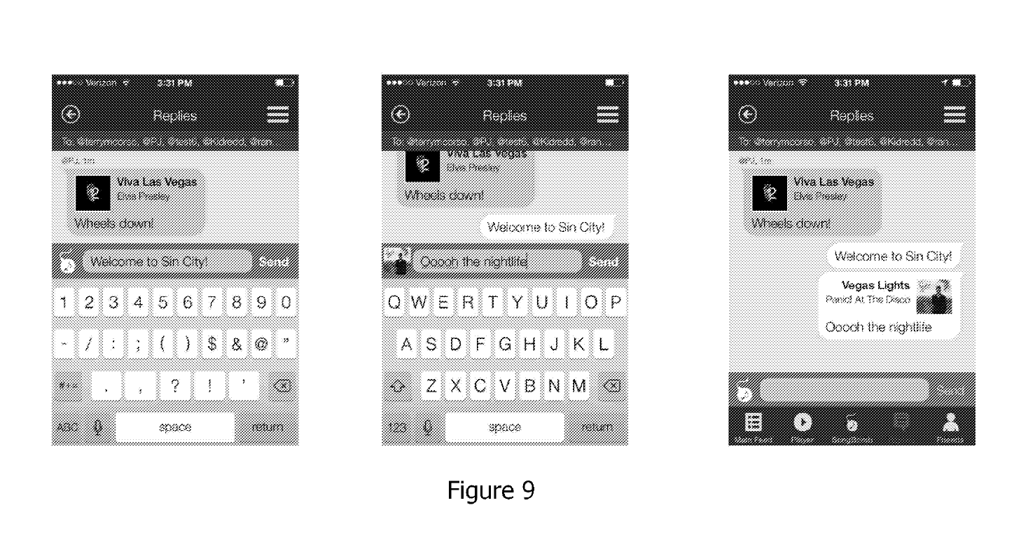

### Messaging (See FIG. 9)

1. User can respond to message like a text
2. User can respond to message AND add a song to that thread
3. Users adding a song boom to the conversation creates a music thread within the message
4. User can play songs directly from the message thread

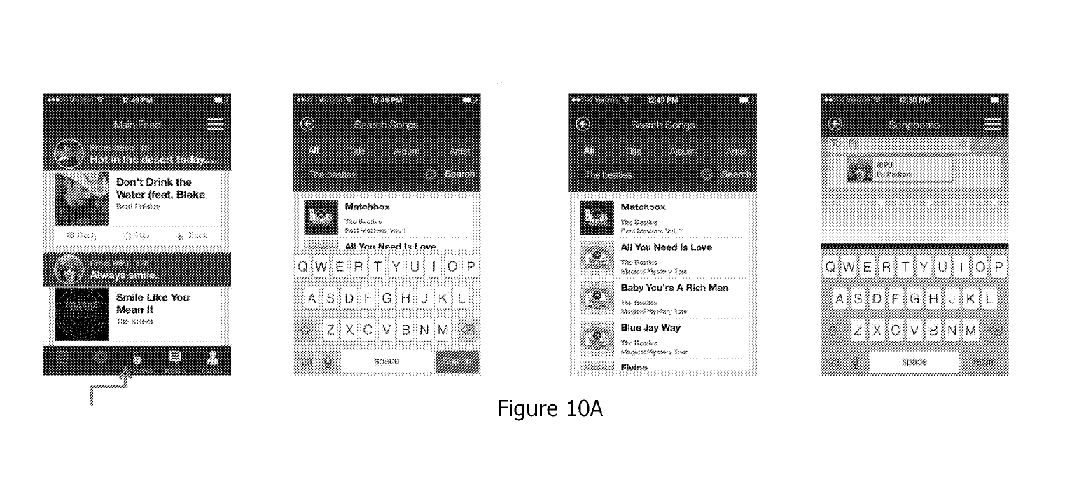

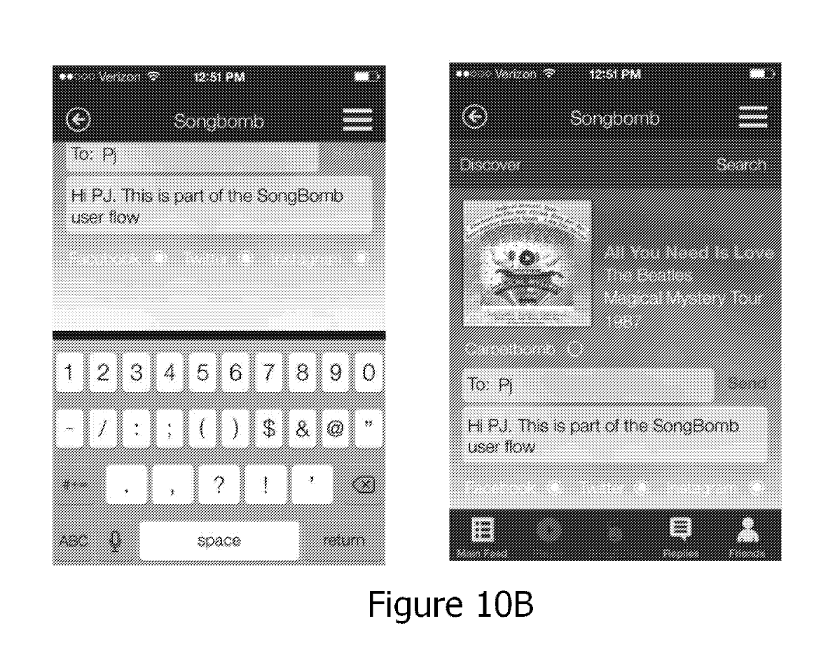

### Sharing A Song (See FIGS. 10A, 10B)

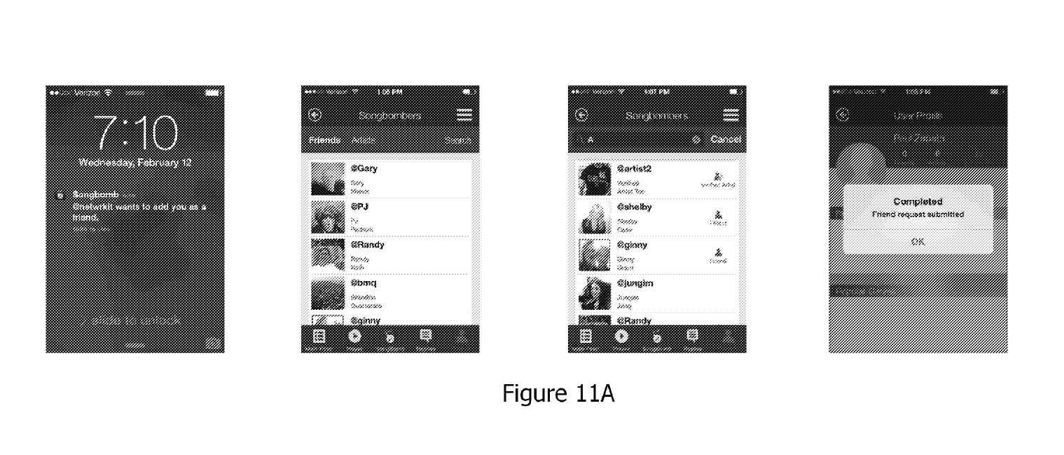

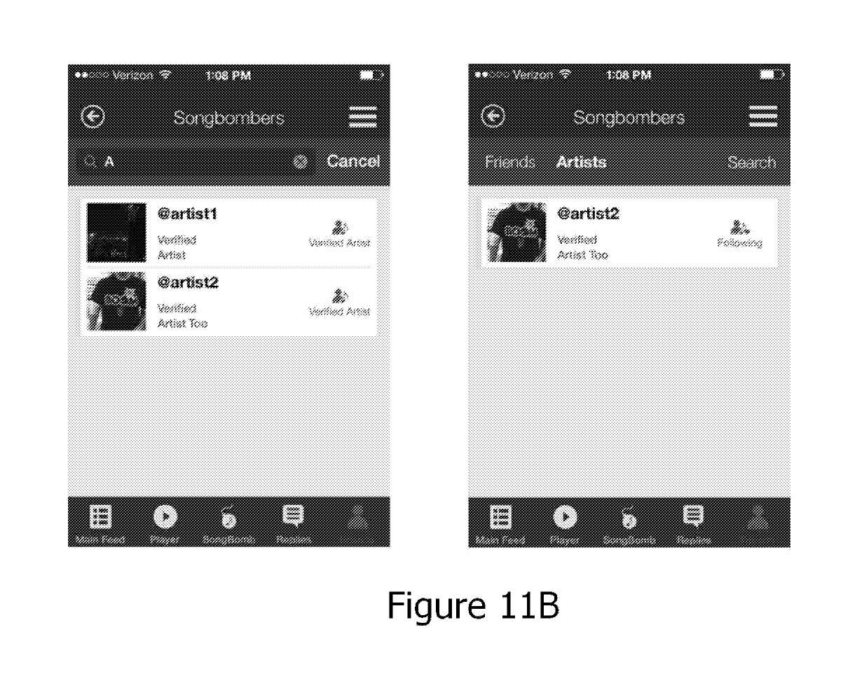

1. Click on Boomio icon
2. Search for song. Filter by All, Artist, Title, Album
3. Find a song and listen to a 0:15 second preview; chose the song
4. Choose recipient(s) from a drop down of my friends, Optionally the user can choose “Carpet Boom” option to send this song to all friends
5. Add a message to the Song
6. Choose to simultaneously post the boom on user's social networks including Facebook, Twitter, Instagram and Google+Friends & Verified Artists (See FIGS. 11A, 11B)
1. User receives a friend request through a lock screen or in-app notification
2. Click on notification to go to friend screen
3. On friend screen user has the option to accept or deny the friend request
4. User wants to add friends
5. User goes to friends screen to search for friends to invite
6. After searching, the user chooses friends to invite and a confirmation of “sent request” appears
7. User wants to follow verified artists
8. User goes to friends screen and searches for verified artist to follow

### User Profile

1. User can choose to view their own profile
2. User can edit the photo of their own profile
3. User can view their own recent activities and genres they listen/share the most
4. User can view others profiles
5. User can view friends(and other user) profiles to see recent activity and popular musical genres the friend enjoys

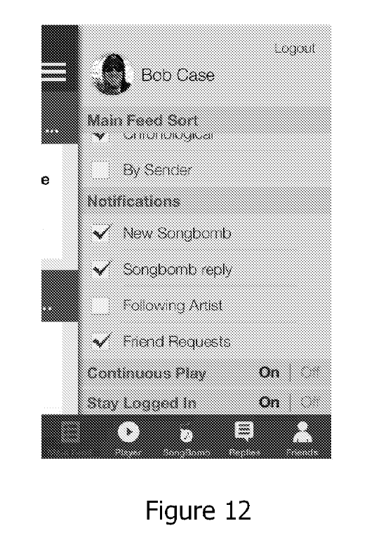

### User Settings (See FIG. 12)

1. User can choose to sort main feed in chronological or by sender order
2. User can turn on/off in app notifications
3. User can choose to listen to Boomio “Threads” of music sent as part of a conversation or the main feed in its entirety

### Registration Process

Create an account on smart phone

Capture the following basic information:
Name, Age, Gender
   Login with FB/Twitter

Collect the following information from FB or Twitter account . . . (same as above)
User is asked if they want to auto include FB friends on Boomio
User is presented terms of use agreement and required to accept
User is presented options to

Allow notifications

Allow use of location information

### Information Capture & Reporting

Usage data is captured for numerous events

Send song, reply to a message w/wo song, “carpetbomb”, play/detonate/preview a song, share a song someone sent, thumbsup/dn, delete thread

All events are captured with location information if user opted in

Usage data is captured for song playback

Playback initiated, playback duration, paused, previewed, thumbsup/dn, detonated

Songs accumulate usage history as more people interact with them, from which trend data can be derived

All data can be compiled together for advanced information, e.g.

Song with most plays over a period of time

Song with most shares over a period of time

Top 5 songs by type of individual (gender, age, location) Behavior of top song sharers

Behavior of top song listeners

Current popular song by location

Data is real-time query-able for use in development of automated reporting systems

Designed to enable periodic, automatic song usage reporting

Can be integrated with any B2B system

No automated reporting currently occurs, waiting for input on how to interface for effective B2B process flow & information exchange

### Server Architecture & Cloud Hosting

In one example, service is 100% hosted on Amazon Web Services

AWS scales well, secure physical premises, maintained 24×7 geographically unlimited There are lower cost options that we will pursue long-term as we grow our user base and look to tune the operating cost model

Server architecture

All server endpoints are scale points that auto add machine instances as necessary to meet growing demand

Restful API PHP server

MySQL User Database server

MySQL Song Meta Data Server

S3 streaming file & image content (artwork) server

Cloudfront https frontend for streaming services

Backups and redundancy

Content file servers enjoy replication redundancy at multiple secure facilities.

Databases are backed up daily with 3 backups retained. In addition weekly snapshots of user data are preserved and archived.

### Cloud Service Security

All the servers hosted on AWS are only accessible for administration and development thru accounts which are part of a security group which include the following restrictions:

User authentication required with username, password, AWS Access Key & AWS

Secret

Key

Users must login from a computer with a specific host IP address

All other access is enabled only thru the app.

The app accesses content on the servers via Restful APIs and, from that data acquires url paths to streaming content as necessary for playback on demand.

There are no hard coded paths to content in the app, only the Restful APIs remain constant.

Each API access requires user authentication via username and password along with a unique device Vendor ID and account access key.

API calls are not cached, authentication is required for every call.

Hooks are provided for increasing the number of ways in which content is accessed, particularly automated usage reporting via 626 interfaces

### Streaming Music Content Format and Structure

The App uses HTTP Live Streaming (HLS) protocol. The open architecture and availability of tools means there have been lots of installations of this technology that has led to a mature and reliable protocol. Benefits of HLS include:
Hosting from HTTP(s) servers greatly simplifies development, operating & maintenance costs.
The content itself supports rotating encryption keys to secure each file from unauthorized access or use.
HLS supports both video and/or audio for use with music videos
HLS provides the ability to time metadata with the content for expression of ads
The ability to adjust to hop to adjacent bitrates during playback for optimal play experience for users with varying connection speeds
Compatibility with Apple iPhone core system AV player
   The final streaming music format is MP3 and on the device is rendered via Apple's AV Player that supports MP3.

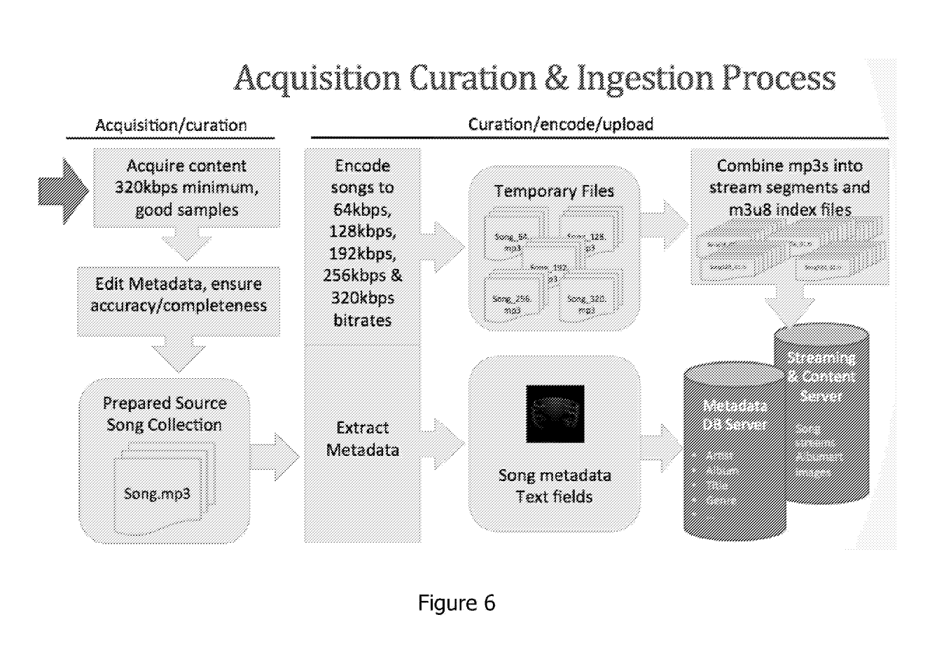

### Streaming Music Content Ingestion Process (See FIG. 6)

The streaming music content ingestion process is automated via batch scripts written in Python.

The scripts are designed to enable manual intervention between steps to inspect results along the way.

This is primarily because the source content derived from various individual collections of music are of widely varying consistency with respect to bitrates, file/folder structure, file naming, metadata completeness and album art inclusion.

The scripts can be easily incorporated into an end-to-end automated process to increase efficiency and expedite processing. Doing so depends on a consistent structure and format of source content.

An example process works like this:

Start with high-quality MP3 source files. Analyze source file for complete/accurate metadata & album art included.

Convert to selected streaming bitrate and extract metadata information, 64 kbps, 128 kbps, 192 kbps . . . up to 256 kbps & 320 kbps if source allows. Higher is better, but requires more bandwidth. To support multiple connection speeds we use a range of bitrates. iTunes store currently requires 64 kbps min for streaming apps.

We use the LAME MP3 command line converter. High quality conversion takes several seconds a song for 64 kbps, so this process can run for days. Metadata is extracted from mp3s and placed in .SBM files used later during ingestion.

Converting the encoded MP3s from each bitrate into streaming segment files. For this step we use the Apple authored, open mediafilesegmenter tool to build the segments (−10s each) and combine into one file for storage convenience on the server.

In addition we use Apple's variantplaylistcreator to define the song playlist file and handle variable bitrate streaming Streaming begins with one of two bitrates (64K or 192K) depending on connection speed. Protocol in the system automatically shifts to slower or faster speeds based on connection throughput during streaming playback. Ingestion happens in two steps

The files are uploaded to a staging server where the transfer is validated.

Then they are tested using the mediastreamvalidator, and if successful transferred to the production environment.

During the final transfer the metadata is uploaded into the database rendering the content immediately available via the app.

### On Device Software

The streaming architecture used for playback on the device desirably does not support offline caching of any type. There is also desirably no ability to download content, so live streaming is the only means for which a user can access music content.

Music metadata and album artwork is cached locally on the device while it remains active in the users feed. Caching metadata content in local storage greatly improves system performance & user experience and optimizes for least amount of data network usage. All cached data is private to the app and not accessible by any other means on the phone. If the app is deleted, all content is erased.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. A system for music-based social interaction, the system comprising:
means for a first user to select a song for sharing with a second user;
means for sharing the song with a verbal message attached to it;
means for the second user to receive a notice that the song is available to be played on a device controlled by the second user;
means for the second user to play the song and read the message;
means to visualize on the second user's device a count-down display graphically showing the progress of the song in its play from beginning to end;
means to automatically erase the song from the second user's device after play is completed, unless the second user elects either to buy it, or to send it further along to a third user, in which case, for every further send along to the third or subsequent users, the second user has the right to play the song one more time.
